(19) United States
(12) Patent Application Publication
(10) Pub. No.: US 2025/0385588 A1
(43) Pub. Date: Dec. 18, 2025

(54) STEPPER MOTOR

(71) Applicant: AAC Microtech (Changzhou) Co., Ltd., Changzhou City (CN)

(72) Inventors: Hongmei Yan, Changzhou (CN); Xixi Zou, Changzhou (CN); Xia Zheng, Changzhou (CN)

(21) Appl. No.: 18/988,925

(22) Filed: Dec. 20, 2024

Related U.S. Application Data
(63) Continuation of application No. PCT/CN2024/098671, filed on Jun. 12, 2024.

(51) Int. Cl. H02K 37/14; H02K 5/16

(52) U.S. Cl. CPC H02K 37/14; H02K 5/161

(57) ABSTRACT

Provided is a stepper motor including a housing, a stator assembly, and a rotor assembly. The stator assembly includes iron cores provided on opposite sides of the rotor assembly along a first direction, and at least two driving units spaced apart along an axial direction of the rotor assembly. Each driving unit includes at least three sub-driving structures along a second direction, and each sub-driving structure includes at least one winding. The first direction, the second direction and the axial direction are perpendicular to each other. The rotor assembly is provided within a driving range of the driving unit, and includes at least two sub-rotor assemblies. One sub-rotor assembly is provided between adjacent sub-driving structures, and each sub-rotor assembly is shared by the at least two driving units. The stepper motor of the present application has a simple structure, is easy to assemble, and facilitates the improvement of torque.

### CROSS-REFERENCE TO RELATED APPLICATIONS

This application is a continuation of International Application No. PCT/CN2024/098671, Jun. 12, 2024, the entire contents of which are incorporated herein by reference.

### TECHNICAL FIELD

The present application relates to the field of motor technologies, in particular to a stepper motor.

### BACKGROUND

Stepper motors, due to their compact structure, high power density, high efficiency, and significant energy-saving and consumption-reducing benefits, have been widely used in fields such as motors and generators. In recent years, the industrial sector has seen a growing demand for devices that use stepper motors to directly drive loads. The widespread adoption of these stepper motor direct-drive devices is expected to yield immense energy-saving benefits.

In the related art, most traditional miniature stepper motors are permanent magnet stepper motors with claw-pole structures. In claw-pole motors, the rotor is a permanent magnet, and two stator cores axially cooperate to form claw-shaped poles, enabling motor rotation through the interaction of the stator and rotor. Besides, the claw pole is a critical component in this motor and is typically manufactured using multi-step stamping processes. However, the traditional claw-pole structures are complex, difficult to form, and suffer from poor process consistency. Additionally, the external design of most miniature stepper motors is circular, requiring special considerations during installation. Furthermore, the magnetic circuit is prone to saturation, making it challenging to improve the torque.

Therefore, it is necessary to provide a new stepper motor to solve the above technical problems.

### SUMMARY

An object of the present application is to provide a stepper motor having a simple structure, easy to assemble, and easy to increase torque.

In order to achieve the above object, the present application provides a stepper motor comprising a housing, a stator assembly fixed to the housing, and a rotor assembly supported in the housing and rotatably connected to the housing, the stator assembly being provided around the rotor assembly and spaced apart from the rotor assembly;
wherein the stator assembly comprises iron cores provided on opposite sides of the rotor assembly along a first direction and fixed to the housing, and at least two driving units spaced apart along an axial direction of the rotor assembly, wherein each of the driving units comprises at least three sub-driving structures spaced apart from each other along a second direction, and each of the sub-driving structure comprises at least one winding; the first direction and the second direction are perpendicular to each other and are perpendicular to the axial direction of the rotor assembly;
the rotor assembly is provided within a driving range of the driving units; the rotor assembly comprises at least two sub-rotor assemblies spaced apart from each other and provided in parallel; one of the sub-rotor assemblies is provided between the adjacent sub-driving structures along the second direction, and each of the sub-rotor assemblies is shared by the at least two driving units;
each of the sub-rotor assemblies comprises a rotatable rotor shaft fixed to the housing and a magnet group fixed to the rotor shaft; the magnet group comprises at least two magnets spaced apart along the axial direction of the rotor shaft; a magnetizing direction of each of the magnets is perpendicular to the axial direction of the rotor assembly; magnetizing directions of the adjacent magnets provided on the same rotor shaft are perpendicular to each other; and the magnets provided on the adjacent rotor shafts and opposite along the second direction have the same or opposite magnetizing direction.

In one embodiment, the stator assembly further comprises frames fixing each of the windings to the iron cores; at least one of the frames is provided separately from the iron cores and/or at least one of the frames is provided integrally with the iron cores.

In one embodiment, when the frames are provided separately from the iron cores, each of the iron cores further comprises countersunk holes formed by recessing in the first direction from a side close to the rotor assembly; the countersunk holes correspond to the frames one by one and the frames are assembled in the countersunk holes.

In one embodiment, the driving units comprise a first driving unit and a second driving unit distributed along the axial direction of the rotor assembly; the iron cores comprise a first iron core and a second iron core provided on both sides of the first driving unit along the first direction, and a third iron core and a fourth iron core provided on both sides of the second driving unit along the first direction; the first driving unit comprises a first sub-driving structure, a second sub-driving structure and a third sub-driving structure spaced apart from each other along the second direction and fixed to the first iron core and/or the second iron core; the second driving unit comprises a fourth sub-driving structure, a fifth sub-driving structure, and a sixth sub-driving structure spaced apart from each other along the second direction and fixed to the third iron core and/or the fourth iron core; the first sub-driving structure, the second sub-driving structure, the fourth sub-driving structure, and the fifth sub-driving structure form a first accommodating space; the second sub-driving structure, the third sub-driving structure, the fifth sub-driving structure, and the sixth sub-driving structure form a second accommodating space, and the first accommodating space and the second accommodating space are both provided with one of the sub-rotor assemblies.

In one embodiment, the rotor assembly comprises a first sub-rotor assembly provided within the first accommodating space and a second sub-rotor assembly provided within the second accommodating space;
the first sub-rotor assembly comprises a first rotor shaft, a first magnet and a second magnet fixedly sleeved on the first rotor shaft; the first magnet and the second magnet are spaced apart along the axial direction of the first rotor shaft, and two ends of the first rotor shaft are rotatably connected to the housing;
the second sub-rotor assembly comprises a second rotor shaft, a third magnet and a fourth magnet fixedly sleeved on the second rotor shaft; the third magnet and the fourth magnet are spaced apart along the axial direction of the second rotor shaft, and two ends of the second rotor shaft are rotatably connected to the housing; along the second direction, the first magnet and the third magnet are provided opposite the first driving unit, and the second magnet and the fourth magnet are provided opposite the second driving unit.

In one embodiment, the first sub-driving structure, the second sub-driving structure, the third sub-driving structure, the fourth sub-driving structure, the fifth sub-driving structure, and the sixth sub-driving structure are each provided with at least two windings; and the two windings are distributed along the axial direction of the rotor shaft.

In one embodiment, the stator assembly further comprises a third driving unit, which is spaced apart on a side of the second driving unit away from the first driving unit; the iron core further comprises a fifth iron core and a sixth iron core provided on both sides of the third driving unit along the first direction; the third driving unit comprises a seventh sub-driving structure, an eighth sub-driving structure, and a ninth sub-driving structure spaced apart from each other along the second direction and fixed to the fifth iron core and/or the sixth iron core; the first sub-rotor assembly further comprises a fifth magnet sleeved on the first rotor shaft and located on a side of the second magnet away from the first magnet; the second sub-rotor assembly further comprises a sixth magnet sleeved on the second rotor shaft and located on a side of the fourth magnet away from the third magnet; the fifth magnet and the sixth magnet are provided opposite the third driving unit along the second direction.

In one embodiment, the housing comprises a first cover plate and a second cover plate provided opposite each other along the axial direction of the rotor assembly, wherein a side of the first iron core away from the second driving unit and a side of the second iron core away from the second driving unit are fixed to the first cover plate; a side of the fifth iron core away from the second driving unit and a side of the sixth iron core away from the second driving unit are fixed to the second cover plate; two ends of the first rotor shaft and two ends of the second rotor shaft are rotatably connected to the first cover plate and the second cover plate, respectively.

In one embodiment, the stepper motor further comprises spacers sleeved on each of the rotor shafts, wherein the spacers are provided between the magnet group and the housing and/or between the adjacent magnets of the magnet group.

In one embodiment, the stepper motor further comprises magnetic spacers sleeved on the rotor assembly, wherein the magnetic spacers are fixedly sandwiched between the two adjacent driving units.

In one embodiment, the stepper motor further comprises bearings fixing the rotor shaft of each of the sub-rotor assemblies to the housing.

In one embodiment, the iron cores are formed by stacking multiple layers of iron sheets.

Compared with the related art, in the stepper motor of the present application, the rotor assembly is supported on the housing and rotatably connected to the housing, and the stator assembly is provided around the rotor assembly and spaced apart from the rotor assembly. The stator assembly includes iron cores provided on opposite sides of the rotor assembly along a first direction and fixed to the housing, and at least two driving units spaced apart along an axial direction of the rotor assembly, wherein each of the driving units comprises at least three sub-driving structures spaced apart from each other along a second direction, and each of the sub-driving structure comprises at least one winding; the first direction and the second direction are perpendicular to each other and are perpendicular to the axial direction of the rotor assembly. The rotor assembly is provided within a driving range of the driving units; the rotor assembly includes at least two sub-rotor assemblies spaced apart from each other and provided in parallel; one of the sub-rotor assemblies is provided between the adjacent sub-driving structures along the second direction, and each of the sub-rotor assemblies is shared by the at least two driving units. Each of the sub-rotor assemblies includes a rotatable rotor shaft fixed to the housing and a magnet group fixed to the rotor shaft; the magnet group comprises at least two magnets spaced apart along the axial direction of the rotor shaft; a magnetizing direction of each of the magnets is perpendicular to the axial direction of the rotor assembly; magnetizing directions of the adjacent magnets provided on the same rotor shaft are perpendicular to each other; and the magnets provided on the adjacent rotor shafts and opposite along the second direction have the same or opposite magnetizing direction, thereby achieving dual or multiple rotational outputs, significantly enhancing motor torque by sharing the magnetic circuit. It ensures excellent synchronization between multiple shafts, making it suitable for multi-shaft transmission scenarios. By configuring the structural relationship between the first and second driving units and the rotor assemblies, the stepper motor in the present application achieves high spatial utilization, facilitating miniaturized designs. Furthermore, its simple structure allows for convenient overall assembly of the stepper motor, further reducing production requirements and costs.

### BRIEF DESCRIPTION OF THE DRAWINGS

In order to more clearly illustrate the technical solutions in the embodiments of the present application, the accompanying drawings to be used in the description of the embodiments will be briefly introduced below. Obviously, the accompanying drawings in the following description are only some embodiments of the present application, and for the person of ordinary skill in the field, other accompanying drawings may be obtained based on these drawings without putting forth any creative labor.

FIG. 1 shows a three-dimensional structural schematic diagram of a stepper motor according to Embodiment one of the present application.

FIG. 2 shows an exploded view of the three-dimensional structure of the stepper motor according to Embodiment one of the present application.

FIG. 3 shows a sectional view of line A-A of FIG. 1.

FIG. 4 shows a structural schematic diagram of a countersunk hole according to Embodiment one of the present application.

FIG. 5 shows a schematic diagram of the stacking of the iron cores according to Embodiment one of the present application.

FIG. 6 shows a first schematic diagram of iron cores according to Embodiment one of the present application.

FIG. 7 shows a second schematic diagram of the iron cores according to Embodiment one of the present application.

FIG. 8 shows a third schematic diagram of the iron cores according to Embodiment one of the present application.

FIG. 9 shows a fifth schematic diagram of the iron cores according to Embodiment one of the present application.

FIG. 10 is a first diagram showing a motion state of the stepper motor according to Embodiment one of the present application.

FIG. 11 is a second diagram showing the motion state of the stepper motor according to Embodiment one of the present application.

FIG. 12 is a third diagram showing the motion state of the stepper motor according to Embodiment one of the present application.

FIG. 13 is a fourth diagram showing the motion state of the stepper motor according to Embodiment one of the present application.

FIG. 14 shows a three-dimensional structural schematic diagram of the stepper motor according to Embodiment two of the present application.

FIG. 15 shows an exploded view of the three-dimensional structure of the stepper motor according to Embodiment two of the present application.

FIG. 16 shows a three-dimensional structural schematic diagram of the stepper motor according to Embodiment three of the present application.

FIG. 17 shows an exploded view of the three-dimensional structure of the stepper motor according to Embodiment three of the present application.

### DETAILED DESCRIPTION OF THE EMBODIMENTS

The technical solutions in the embodiments of the present application will be described clearly and completely in the following in conjunction with the accompanying drawings in the embodiments of the present application. Obviously, the described embodiments are only a part of the embodiments of the present application and not all of the embodiments. Based on the embodiments in the present application, all other embodiments obtained by a person of ordinary skill in the art without making creative labor fall within the scope of protection of the present application.

### Embodiment One

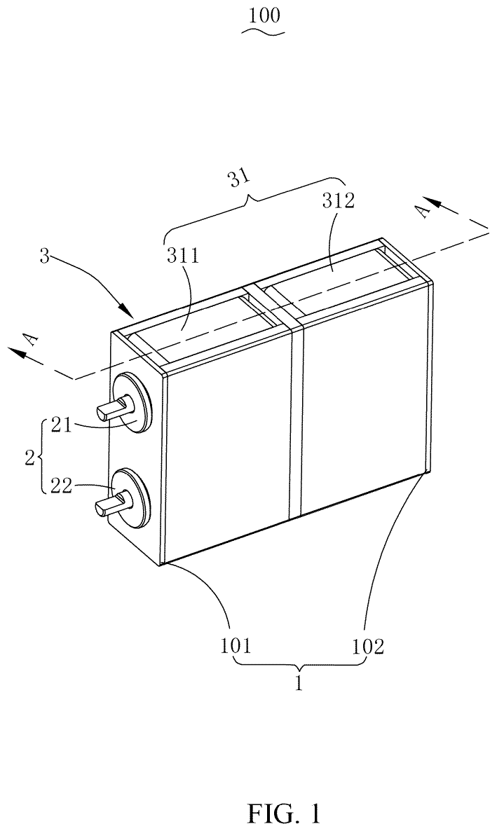

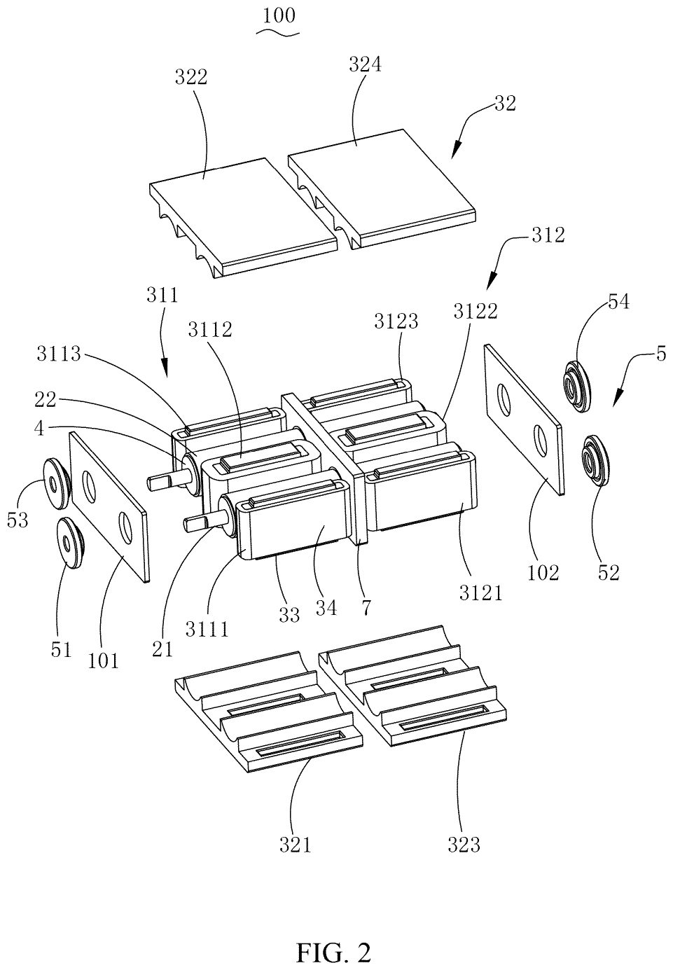

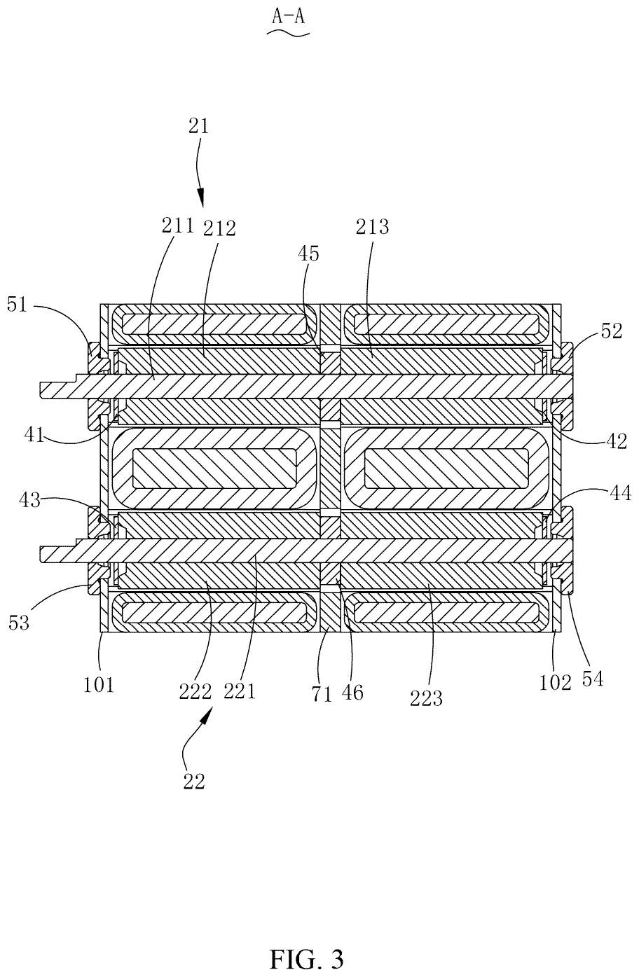

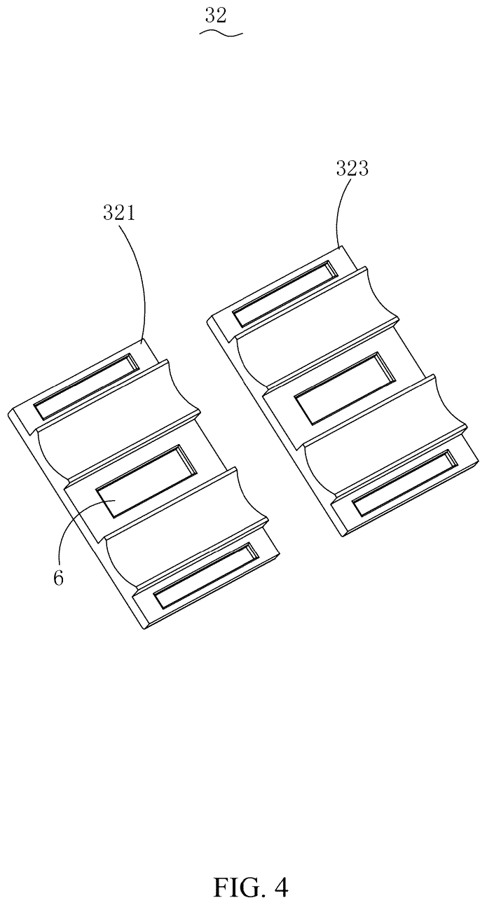

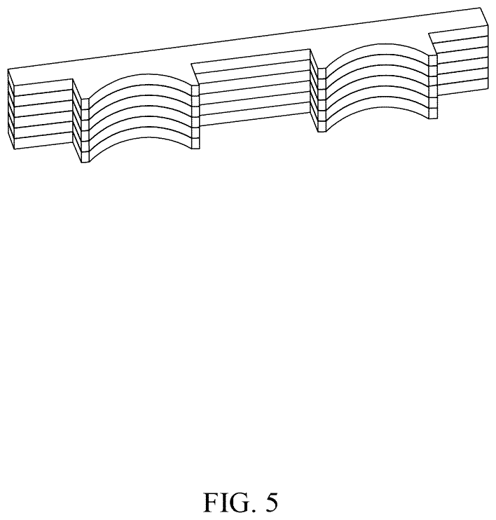

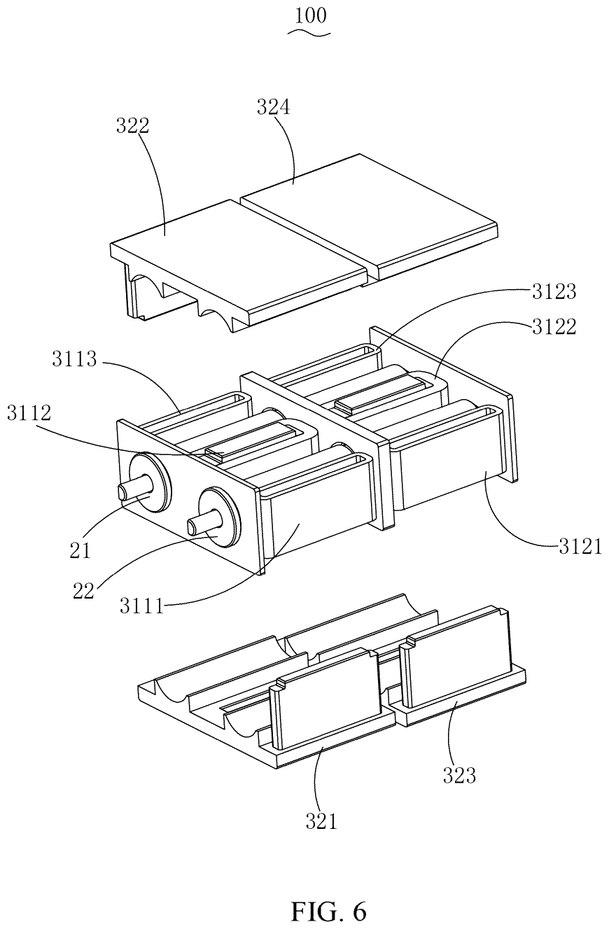

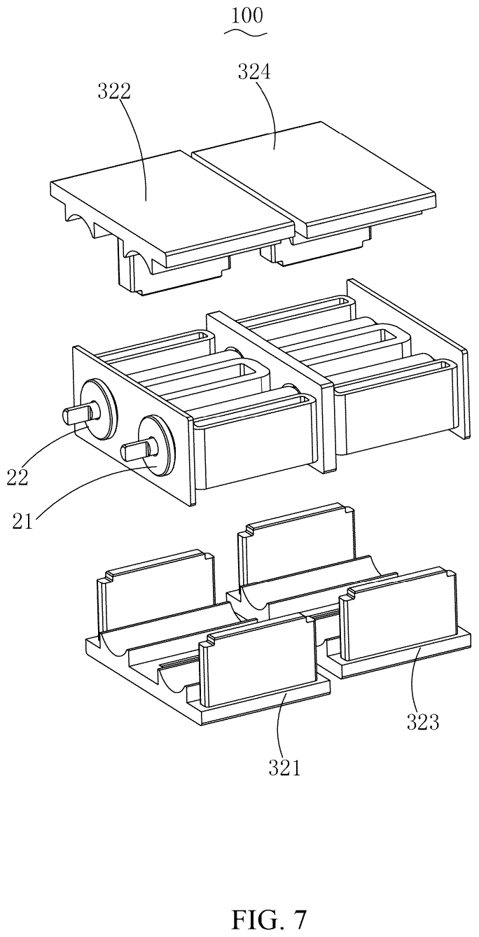

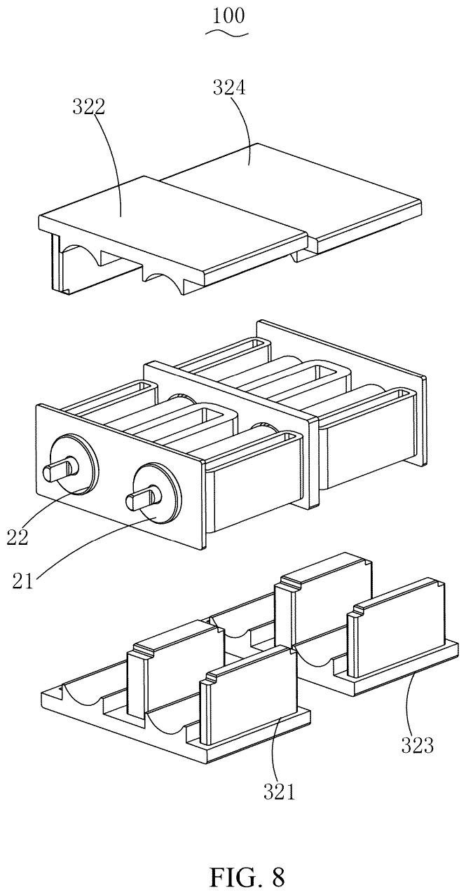

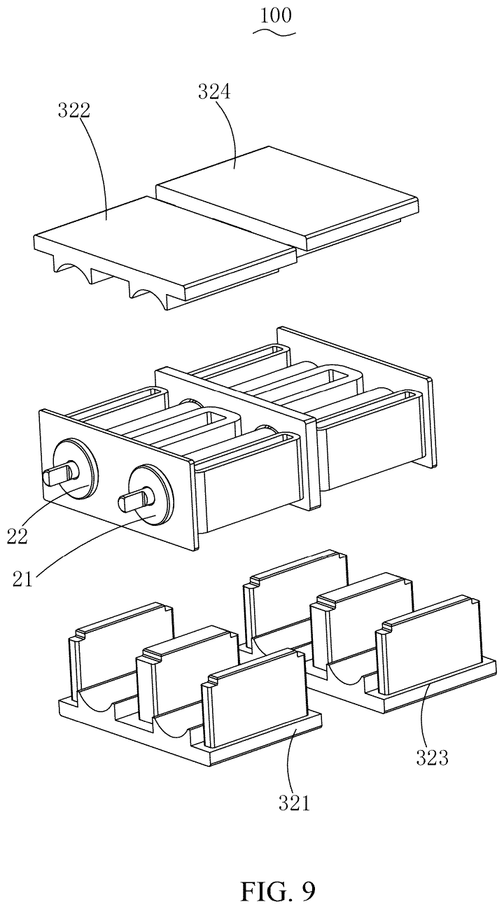

As shown in FIGS. 1 to 13, an embodiment of the present application provides a stepper motor 100 including a housing 1, a stator assembly 3 fixed in the housing 1, and a rotor assembly 2 supported in the housing 1 and rotatably connected to the housing 1. The stator assembly 3 is provided around the rotor assembly 2 and spaced apart from the rotor assembly 2. The housing 1 is configured to support and set the stator assembly 3 and the rotor assembly 2, and the stator assembly 3 interacts with the rotor assembly 2 to generate a magnetic field to drive the rotor assembly 2 to rotate on the housing 1, realizing the driving function of the stepping motor 100

In this embodiment, the stator assembly 3 includes iron cores 32 provided on opposite sides of the rotor assembly 2 along a first direction and fixed to the housing 1, and at least two driving units 31 spaced apart along the axial direction of the rotor assembly 2. Each driving unit 31 includes at least three sub-driving structures spaced apart from each other along a second direction, and each sub-driving structure includes at least one winding 34. the first direction and the second direction are perpendicular to each other and are perpendicular to the axial direction of the rotor assembly 2. In an embodiment, the iron cores 32 are set in a rectangular structure. By providing the rectangular-shaped iron cores 32, the sub-driving structures and the iron cores 32 as a whole form a rectangular structure, which has high space utilization and facilitates miniaturization design

The rotor assembly 2 is provided within a driving range of the driving unit 31. The rotor assembly 2 includes at least two sub-rotor assemblies 2 spaced apart from each other and provided in parallel. One of the sub-rotor assemblies 2 is provided between the adjacent sub-driving structures along the second direction, and each of the sub-rotor assemblies 2 is shared by the at least two driving units 31.

Each sub-rotor assembly 2 includes a rotatable rotor shaft fixed to the housing 1 and a magnet group fixed to the rotor shaft. The magnet group includes at least two magnets spaced apart along the axial direction of the rotor shaft. A magnetizing direction of each magnet is perpendicular to the axial direction of the rotor assembly 2. The magnetizing directions of the magnets provided on the same rotor shaft are perpendicular to each other, and the magnets provided on the adjacent rotor shafts and opposite along the second direction have the same or opposite magnetizing direction, thereby achieving dual or multiple rotational outputs, significantly enhancing motor torque by sharing the magnetic circuit. The first driving unit 311 and the second driving unit 312 achieve high spatial utilization, facilitating miniaturized designs. Additionally, the simple structure allows for easy overall assembly of the stepper motor 100.

In this embodiment, the stator assembly 3 further includes frames 33 fixing each winding 34 to the iron cores 32. At least one of the frames 33 is provided separately from the iron cores 32 and/or at least one of the frames 33 is provided integrally with the iron core 32.

Specifically, in the assembly process, the windings 34 are first wound on the frames 33, and the frames with the windings 34 are then mounted within the iron core 32 using tabs at both ends.

In this embodiment, when the frames 33 are provided separately from the iron core 32, each iron core 32 further includes countersunk holes 6 formed by recessing along the first direction from a side close to the rotor assembly 2. The countersunk holes 6 correspond to the frame 33 one by one and the frames 33 are assembled within the countersunk holes 6, facilitating a fixed connection between the frames 33 and the iron cores 32.

In an embodiment, the frames 33 with the set of windings 34 are fixedly connected to the iron core 32 by welding or bonding.

In this embodiment, both the iron core 32 and the frame 33 are made of strongly magnetically conductive material.

In an embodiment, the first iron core 321 or the second iron core 322 may also have its own long arm structure (e.g., frame 33). Firstly, the winding is wound on the long arm structure of the iron core 32, and the iron core 32 with the winding 34 is then mounted within the countersunk hole of the opposite iron cores 32 using tabs on two ends of the long arm. In an embodiment, the iron core 32 with windings 34 may be attached to the opposite iron core 32 by means of welding or bonding.

In an embodiment, the long arm structures of the windings 34 are all centered on the iron core 32 at one side, and the other iron core 32 includes a countersink hole where the long arm structures can be mounted.

In an embodiment, the windings are first wound on the long arms of the iron core 32, and the iron core 32 with the windings 34 is then mounted within the countersunk holes of the opposite core 32 using tabs on the end faces of the long arms.

In an embodiment, the iron core 32 with windings 34 may be attached to the opposite iron core 32 by welding or bonding.

In this embodiment, the driving units 31 include a first driving unit 311 and a second driving unit 312 distributed along the axial direction of the rotor assembly 2. The iron cores 32 include a first iron core 321 and a second iron core 322 provided on both sides of the first driving unit 311 along the first direction, and a third iron core 323 and a fourth iron core 324 provided on both sides of the second driving unit 312 along the first direction. The first driving unit 311 includes a first sub-driving structure 3111, a second sub-driving structure 3112 and a third sub-driving structure 3113 spaced apart from each other along the second direction and fixed to the first iron core 321 and/or the second iron core 322. The second driving unit 312 includes a fourth sub-driving structure 3121, a fifth sub-driving structure 3122, and a sixth sub-driving structure 3123 spaced apart from each other along the second direction and fixed to the third iron core 323 and/or the fourth iron core 324. The first sub-driving structure 3111, the second sub-driving structure 3112, the fourth sub-driving structure 3121, and the fifth sub-driving structure 3122 form a first accommodating space. The second sub-driving structure 3112, the third sub-driving structure 3113, the fifth sub-driving structure 3122, and the sixth sub-driving structure 3123 form a second accommodating space. The first accommodating space and the second accommodating space are each provided with one sub-rotor assembly 2.

In this embodiment, the rotor assembly 2 includes a first sub-rotor assembly 21 provided within the first accommodating space and a second sub-rotor assembly 22 provided within the second accommodating space.

The first sub-rotor assembly 21 includes a first rotor shaft 211, a first magnet 212 and a second magnet 213 fixedly sleeved on the first rotor shaft 211. The first magnet 212 and the second magnet 213 are spaced apart along the axial direction of the first rotor shaft 211, and the two ends of the first rotor shaft 211 are rotatably connected to the housing 1.

The second sub-rotor assembly 22 includes a second rotor shaft 221, and a third magnet 222 and a fourth magnet 223 fixedly sleeved on the second rotor shaft 221. The third magnet 222 and the fourth magnet 223 are spaced apart along the axial direction of the second rotor shaft 221, and two ends of the second rotor shaft 221 are rotatably connected to the housing 1. Along the second direction, the first magnet 212 and the third magnet 222 are provided opposite the first driving unit 311, and the second magnet 213 and the fourth magnet 223 are provided opposite the second driving unit 312.

Specifically, the magnetizing direction of the first magnet 212, the magnetizing direction of the second magnet 213, the magnetizing direction of the third magnet 222, and the magnetizing direction of the fourth magnet 223 are all perpendicular to the axial direction of the rotor assembly 2. The magnetizing direction of the first magnet 212 is in the same direction as the magnetizing direction of the third magnet 222, and the magnetizing direction of the second magnet 213 is in the same direction as the magnetizing direction of the fourth magnet 223. The magnetizing direction of the first magnet 212 and the magnetizing direction of the second magnet 213 are perpendicular to each other. By setting the first driving unit 311 and the second driving unit 312 corresponding to the first magnet 212, the second magnet 213, the third magnet 222, and the fourth magnet 223, utilizing the magnetizing direction of the first magnet 212 and the second magnet 213 always perpendicular to each other, and the magnetizing directions of the third magnet 222 and the fourth magnet 223 are in the same direction as the magnetizing directions of the first magnet 212 and the second magnet 213, respectively, thereby achieving a double-rotation or multiple-rotation output, and greatly increasing the motor torque by sharing the magnetic circuit. The setting of the rectangular-shaped first driving unit 311 and the second driving unit 312 makes high space utilization and facilitates miniaturized design. Besides, the structure is simple and facilitates the overall assembly of the stepping motor 100. Further, production requirements and production costs are reduced.

The first magnet 212, the second magnet 213, the third magnet 222, and the fourth magnet 223 are sintered neodymium-iron-boron magnets, and the grades may be selected as N52SH or other grades. The first magnet 212 and the second magnet 213 are fixed to the first rotating axle 211 by adhesive bonding, and the direction of the magnetizing direction is radially parallel to the magnetization. The magnetizing directions of the first magnet 212 and the second magnet 213 are staggered by 90 degrees. Besides, the third magnet 222 and the fourth magnet 223 are also fixed to the second rotor shaft 221 by adhesive bonding, and the magnetizing direction is radially parallel magnetizing. The magnetizing directions of the third magnet 222 and the fourth magnet 223 are staggered by 90 degrees.

In this embodiment, the frames 33 and the windings 34 of the first driving unit 311 are assembled between the first iron core 321 and the second iron core 322 to form phase A. The frames 33 and the windings 34 of the second driving unit 312 are assembled between the third iron core 323 and the fourth iron core 324 to form phase B.

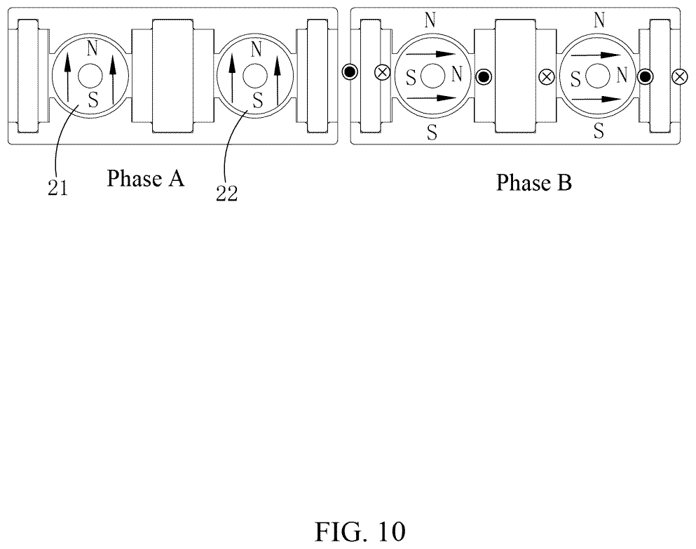

As shown in FIG. 10, at the moment 0˜T/4, the phase B is positively energized, the windings 34 and the magnets are excited in the manner as shown above, and the rotor magnet is subjected to a torque to rotate in the clockwise direction.

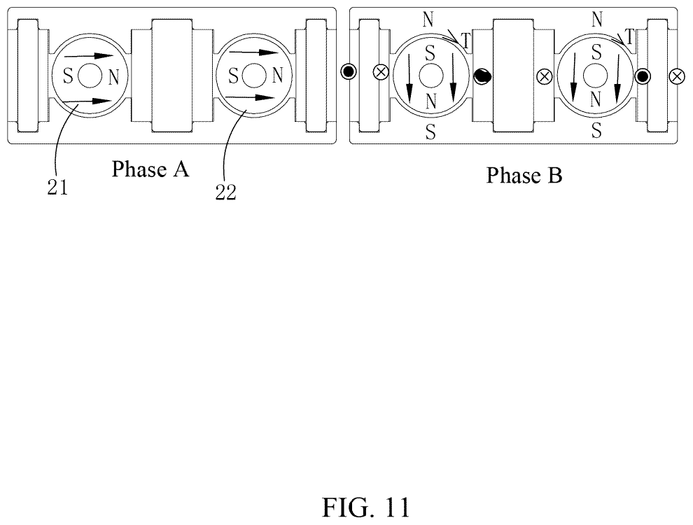

As shown in FIG. 11, a steady-state equilibrium position is reached after rotating one step angle (90 degrees).

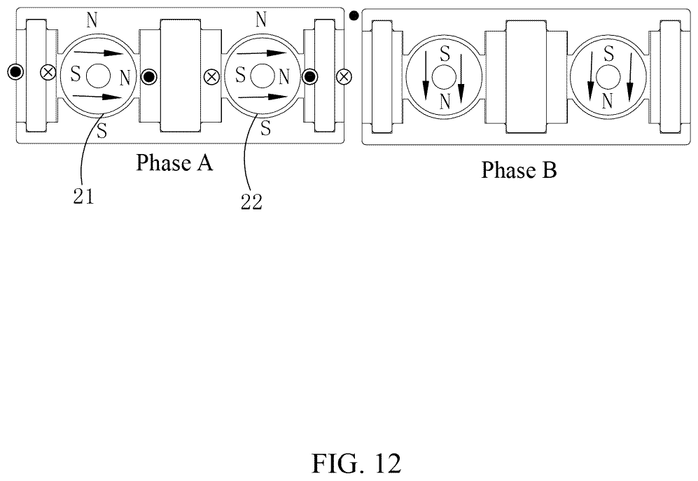

As shown in FIG. 12, at the time of T/4, the phase is changed, phase A is energized positively for a period of T/4, and the rotor magnets are rotated in the clockwise direction by the torque.

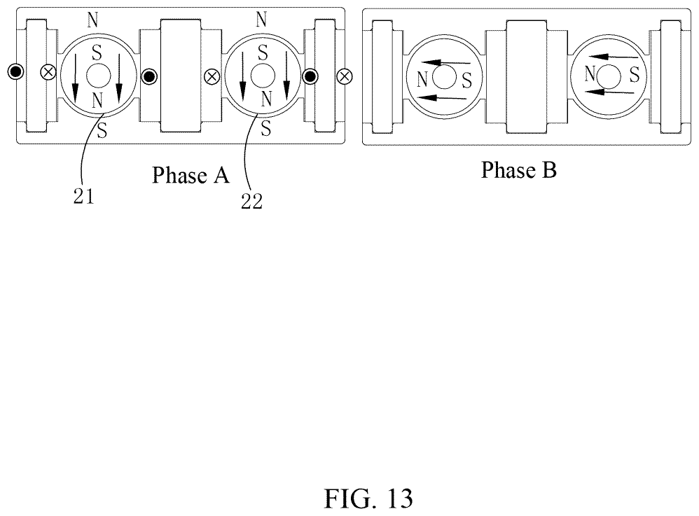

As shown in FIG. 13, after rotating one step angle (90 degrees), the new steady-state equilibrium position is reached. It is assumed that the energized signal is B+→A+→B−→A−→B+ . . . . In this way, driven by a pulse signal, the rotor rotates by one step angle and the motor achieves continuous operation in one direction.

The stepper motor 100 is a common magnetic circuit multi-output shaft square permanent magnet stepper motor, with 100 step angle of 90 degrees and the principle of motion shown in FIGS. 10 to 13. Through the above driving mode, the double rotor synchronous clockwise rotation can be realized, and the counterclockwise rotation can be realized by changing the direction of the energization. The energization may be single-phase energization or may be two-phase energization. The signal may be a square-wave signal or subdivided signal, and the rotational speed may be controlled by the signal frequency.

### Embodiment Two

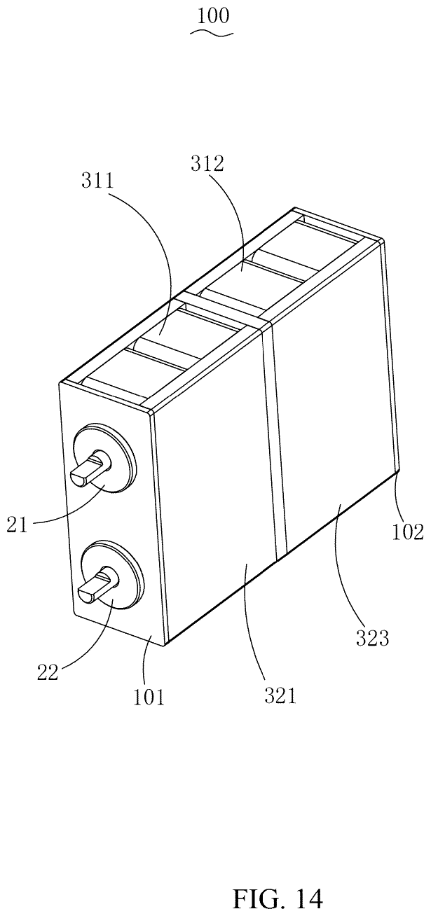

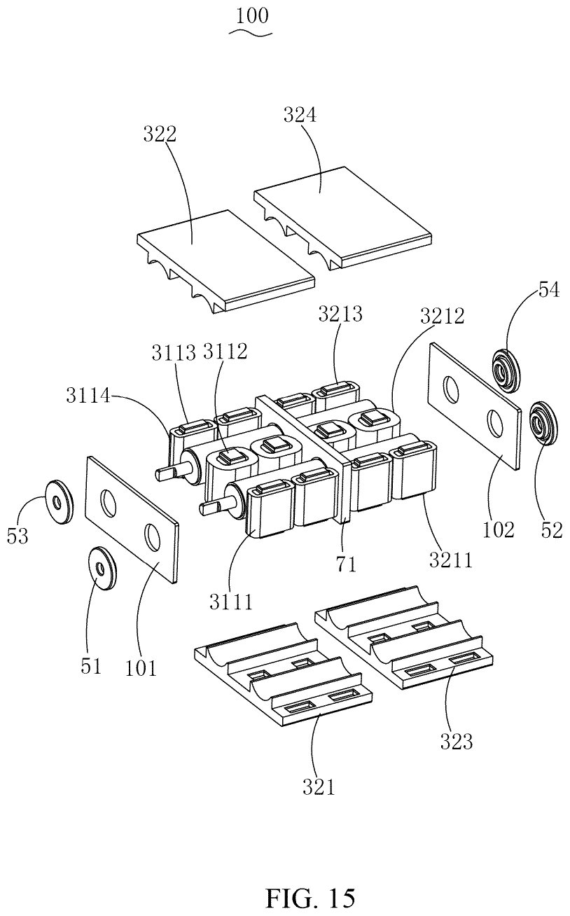

Combined with FIGS. 1 to 15, Embodiment two has the same structure as Embodiment one. On the basis of Embodiment one, the first sub-driving structure 3111, the second sub-driving structure 3112, the third sub-driving structure 3113, the fourth driving structure, the fifth sub-driving structure 3122, and the sixth sub-driving structure 3123 are each provided with at least two windings 34, which are distributed in the axial direction along the rotor shaft. The driving force is increased by increasing the sub-driving structures to improve the rotational performance of the rotor shaft.

### Embodiment Three

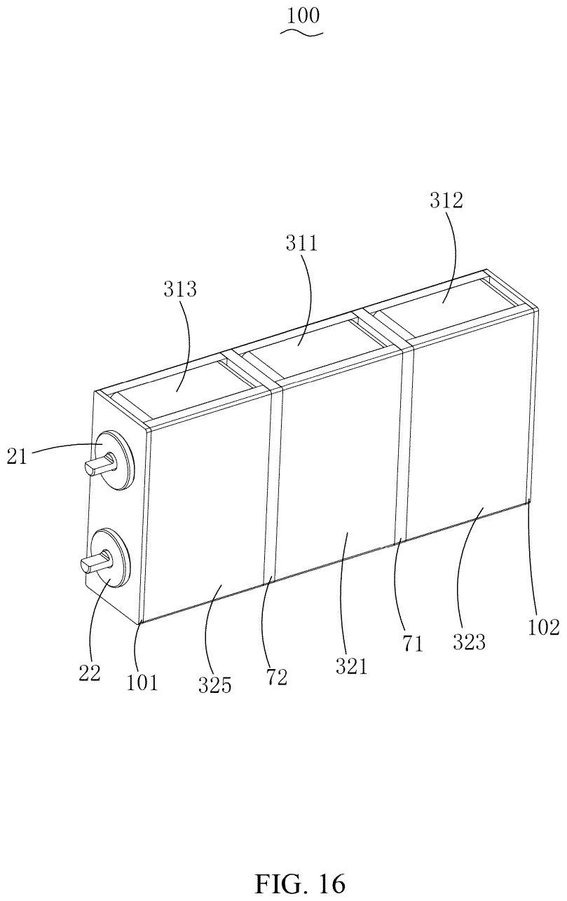

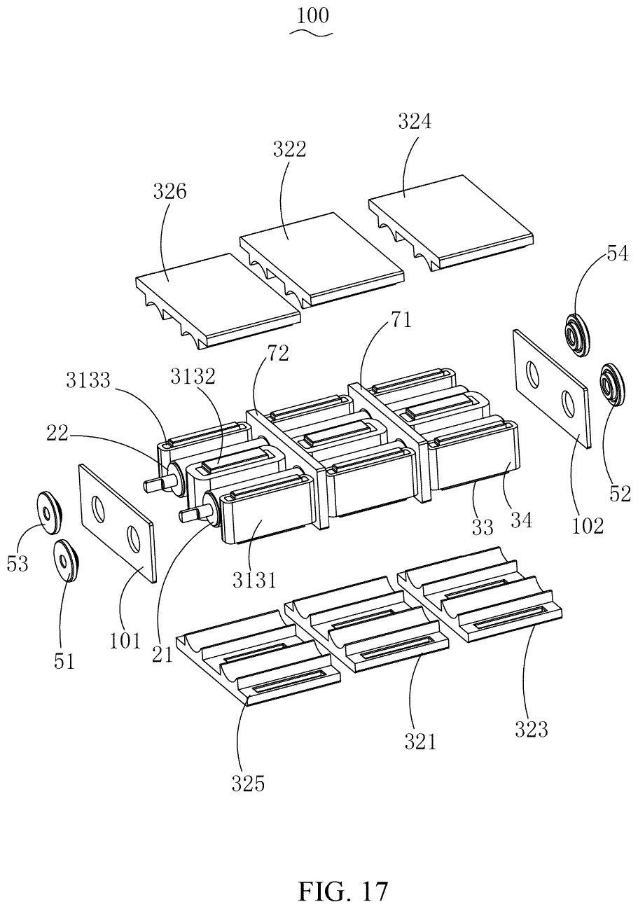

Combined with FIGS. 1 to 17, Embodiment three has the same structure as Embodiment one. On the basis of Embodiment one, the stator assembly 3 further includes a third driving unit 313, which is spaced apart on a side of the second driving unit 312 away from the first driving unit 311. The iron cores 32 further include a fifth iron core 325 and a sixth iron core 326 provided on both sides of the third driving unit 313 along the first direction. The third driving unit 313 includes a seventh sub-driving structure 3131, an eighth sub-driving structure 3132, and a ninth sub-driving structure 3133 spaced apart from each other along the second direction and fixed to the fifth iron core 325 and/or the sixth iron core 326. The first sub-rotor assembly 21 further includes a fifth magnet 214 sleeved on the first rotor shaft 211 and located on a side of the second magnet 213 away from the first magnet 212. The second sub-rotor assembly 22 further includes a sixth magnet 224 sleeved on the second rotor shaft 221 and located on a side of the fourth magnet 223 away from the third magnet 222. The fifth magnet 214 and the sixth magnet 224 are provided opposite the third drive unit 313 along the second direction.

The third driving unit 313 is spaced apart and sleeved on the fourth magnet 223 and the fifth magnet 214, and the magnetizing direction of the fourth magnet 223 and the magnetizing direction of the fifth magnet 214 are the same as or opposite to the magnetizing direction of the second magnet 213 and the magnetizing direction of the fourth magnet 223, respectively. A three-phase motor is formed by the first driving unit 311, the second driving unit 312, and the third driving unit 313 corresponding to the first magnet 212, the second magnet 213, and the fifth magnet 214, respectively. The third driving unit 313 has the same structure as the first driving unit 311 and the second driving unit 312, and it produces the same effect.

In an embodiment, the stepper motor 100 further includes a plurality of magnets, thereby forming a four-phase motor. By the same principle, the stepper motor 100 may also be a five-phase motor, a six-phase motor, etc., which will not be described herein.

In this embodiment, the housing 1 includes a first cover plate 101 and a second cover plate 102 provided opposite each other along the axial direction of the rotor assembly 2. A side of the first iron core 321 away from the second driving unit 312 and a side of the second iron core 322 away from the second driving unit 312 are fixed to the first cover plate 101. A side of the fifth iron core 325 away from the second driving unit 312 and a side of the sixth iron core 326 away from the second driving unit 312 are fixed to the second cover plate 102. the second cover plate 102. Two ends of the first rotor shaft 211 and two ends of the second rotor shaft 221 are rotatably connected to the first cover plate 101 and the second cover plate 102, respectively.

In this embodiment, the stepper motor 100 further includes spacers 4 sleeved on each rotor shaft. The spacers 4 are provided between the magnet group and the housing 1 and/or between the adjacent magnets of the magnet group.

Specifically, the spacers 4 include a first spacer 41, a second spacer 42, a third spacer 43, a fourth spacer 44, a fifth spacer 45, and a sixth spacer 46. The first spacer 41 is sleeved on the first rotor shaft 211 and fixed to an end of the first magnet 212 away from the second magnet 213. The second spacer 42 is sleeved on the first rotor shaft 211 and fixed to an end of the first magnet 212 away from the second magnet 213. The third spacer 43 is sleeved on the second rotor shaft 221 and fixed to an end of the third magnet 222 away from the fourth magnet 223. The fourth spacer 44 is sleeved on the second rotor shaft 221 and fixed to an end of the third magnet 222 away from the fourth magnet 223. The first spacer 41, the second spacer 42, the third spacer 43, and the fourth spacer 44 are mounted to cushion the impact generated by the axial movement of the first rotor shaft 211 and the second rotor shaft 221, thereby improving the rotational performance of the rotor shaft.

The fifth spacer 45 is sleeved on the first rotor shaft 211 and sandwiched between the first magnet 212 and the second magnet 213. The sixth spacer 46 is sleeved on the second rotor shaft 221 and sandwiched between the third magnet 222 and the fourth magnet 223. The fifth spacer 45 and the sixth spacer 46 are plastic spacers 4, and the fifth spacer 45 is fixed between the first magnet 212 and the second magnet 213 by means of bonding, and also provides a magnetic isolation effect.

In this embodiment, the stepper motor 100 further includes magnetic spacers 7 sleeved on the rotor assembly 2, which are fixedly sandwiched between the two adjacent driving units 31.

Specifically, the magnetic spacers 7 include a first spacer 71 and a second spacer 72 sleeved on the rotor assembly 2. The first magnetic spacer 71 is sandwiched between the first driving unit 311 and the second driving unit 312. The first magnetic spacer 71 is made of a non-magnetic conductive material, effectively magnetizing the first driving unit 311 and the second driving unit 312, and improving the performance of the stepper motor 100.

In this embodiment, the stepper motor 100 further includes bearings 5 fixing the rotor shaft of each sub-rotor assembly 2 to the housing 1.

Specifically, the bearings 5 include a first bearing 51, a second bearing 52, a third bearing 53, and a fourth bearing 54. At least part of the peripheral sides of the first bearing 51 and the third bearing 53 are fixed in the first cover plate 101, and at least part of the peripheral sides of the second bearing 52 and the fourth bearing 54 are fixed in the second cover plate 102. The two ends of the first rotor shaft 211 are inserted and fixed to the inner side of the first bearing 51 and the second bearing 52, respectively. The two ends of the second rotor shaft 221 are inserted and fixed to the inner side of the third bearing 53 and the fourth bearing 54, respectively.

The first bearing 51 and the second bearing 52 are fixed to the first cover plate 101 and the second cover plate 102 by welding or riveting, respectively. The first cover plate 101 with the first bearing 51 and the second cover plate 102 with the second bearing 52 are fixed to one side of the first iron core 321 and the third iron core 323, respectively, so as to realize the overall assembly. Similarly, the third bearing 53 and the fourth bearing 54 are mounted in the same manner.

In this embodiment, the iron cores 32 are formed by stacking multiple layers of iron sheets, which can effectively reduce the turbine loss.

Compared with the related art, in the stepper motor of the present application, the rotor assembly is supported on the housing and rotatably connected to the housing, and the stator assembly is provided around the rotor assembly and spaced apart from the rotor assembly. The stator assembly includes iron cores provided on opposite sides of the rotor assembly along a first direction and fixed to the housing, and at least two driving units spaced apart along an axial direction of the rotor assembly, wherein each of the driving units comprises at least three sub-driving structures spaced apart from each other along a second direction, and each of the sub-driving structure comprises at least one winding; the first direction and the second direction are perpendicular to each other and are perpendicular to the axial direction of the rotor assembly. The rotor assembly is provided within a driving range of the driving units; the rotor assembly includes at least two sub-rotor assemblies spaced apart from each other and provided in parallel; one of the sub-rotor assemblies is provided between the adjacent sub-driving structures along the second direction, and each of the sub-rotor assemblies is shared by the at least two driving units. Each of the sub-rotor assemblies includes a rotatable rotor shaft fixed to the housing and a magnet group fixed to the rotor shaft; the magnet group comprises at least two magnets spaced apart along the axial direction of the rotor shaft; a magnetizing direction of each of the magnets is perpendicular to the axial direction of the rotor assembly; magnetizing directions of the adjacent magnets provided on the same rotor shaft are perpendicular to each other; and the magnets provided on the adjacent rotor shafts and opposite along the second direction have the same or opposite magnetizing direction, thereby achieving dual or multiple rotational outputs, significantly enhancing motor torque by sharing the magnetic circuit. It ensures excellent synchronization between multiple shafts, making it suitable for multi-shaft transmission scenarios. By configuring the structural relationship between the first and second driving units and the rotor assemblies, the stepper motor in the present application achieves high spatial utilization, facilitating miniaturized designs. Furthermore, its simple structure allows for convenient overall assembly of the stepper motor, further reducing production requirements and costs.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. A stepper motor, comprising:
a housing;
a stator assembly fixed to the housing; and
a rotor assembly supported in the housing and rotatably connected to the housing, the stator assembly being provided around the rotor assembly and spaced apart from the rotor assembly;
wherein the stator assembly comprises iron cores provided on opposite sides of the rotor assembly along a first direction and fixed to the housing, and at least two driving units spaced apart along an axial direction of the rotor assembly, wherein each of the driving units comprises at least three sub-driving structures spaced apart from each other along a second direction, and each of the sub-driving structure comprises at least one winding; the first direction and the second direction are perpendicular to each other and are perpendicular to the axial direction of the rotor assembly;
the rotor assembly is provided within a driving range of the driving units; the rotor assembly comprises at least two sub-rotor assemblies spaced apart from each other and provided in parallel; one of the sub-rotor assemblies is provided between the adjacent sub-driving structures along the second direction, and each of the sub-rotor assemblies is shared by the at least two driving units;
each of the sub-rotor assemblies comprises a rotatable rotor shaft fixed to the housing and a magnet group fixed to the rotor shaft; the magnet group comprises at least two magnets spaced apart along the axial direction of the rotor shaft; a magnetizing direction of each of the magnets is perpendicular to the axial direction of the rotor assembly; magnetizing directions of the adjacent magnets provided on the same rotor shaft are perpendicular to each other; and the magnets provided on the adjacent rotor shafts and opposite along the second direction have the same or opposite magnetizing direction.

2. The stepper motor of claim 1, wherein each of the stator assemblies further comprises frames fixing each of the windings to the iron cores; at least one of the frames is provided separately from the iron cores and/or at least one of the frames is provided integrally with the iron cores.

3. The stepper motor of claim 2, wherein when the frames are provided separately from the iron cores, each of the iron cores further comprises countersunk holes formed by recessing in the first direction from a side close to the rotor assembly; the countersunk holes correspond to the frames one by one and the frames are assembled in the countersunk holes.

4. The stepper motor of claim 2, wherein the driving units comprise a first driving unit and a second driving unit distributed along the axial direction of the rotor assembly; the iron cores comprise a first iron core and a second iron core provided on both sides of the first driving unit along the first direction, and a third iron core and a fourth iron core provided on both sides of the second driving unit along the first direction; the first driving unit comprises a first sub-driving structure, a second sub-driving structure and a third sub-driving structure spaced apart from each other along the second direction and fixed to the first iron core and/or the second iron core; the second driving unit comprises a fourth sub-driving structure, a fifth sub-driving structure, and a sixth sub-driving structure spaced apart from each other along the second direction and fixed to the third iron core and/or the fourth iron core; the first sub-driving structure, the second sub-driving structure, the fourth sub-driving structure, and the fifth sub-driving structure form a first accommodating space; the second sub-driving structure, the third sub-driving structure, the fifth sub-driving structure, and the sixth sub-driving structure form a second accommodating space, and the first accommodating space and the second accommodating space are both provided with one of the sub-rotor assemblies.

5. The stepper motor of claim 4, wherein the rotor assembly comprises a first sub-rotor assembly provided within the first accommodating space and a second sub-rotor assembly provided within the second accommodating space;
the first sub-rotor assembly comprises a first rotor shaft, a first magnet and a second magnet fixedly sleeved on the first rotor shaft; the first magnet and the second magnet are spaced apart along the axial direction of the first rotor shaft, and two ends of the first rotor shaft are rotatably connected to the housing;
the second sub-rotor assembly comprises a second rotor shaft, a third magnet and a fourth magnet fixedly sleeved on the second rotor shaft; the third magnet and the fourth magnet are spaced apart along the axial direction of the second rotor shaft, and two ends of the second rotor shaft are rotatably connected to the housing; along the second direction, the first magnet and the third magnet are provided opposite the first driving unit, and the second magnet and the fourth magnet are provided opposite the second driving unit.

6. The stepper motor of claim 5, wherein the first sub-driving structure, the second sub-driving structure, the third sub-driving structure, the fourth sub-driving structure, the fifth sub-driving structure, and the sixth sub-driving structure are each provided with at least two windings; and the two windings are distributed along the axial direction of the rotor shaft.

7. The stepper motor of claim 5, wherein the stator assembly further comprises a third driving unit, which is spaced apart on a side of the second driving unit away from the first driving unit; the iron core further comprises a fifth iron core and a sixth iron core provided on both sides of the third driving unit along the first direction; the third driving unit comprises a seventh sub-driving structure, an eighth sub-driving structure, and a ninth sub-driving structure spaced apart from each other along the second direction and fixed to the fifth iron core and/or the sixth iron core; the first sub-rotor assembly further comprises a fifth magnet sleeved on the first rotor shaft and located on a side of the second magnet away from the first magnet; the second sub-rotor assembly further comprises a sixth magnet sleeved on the second rotor shaft and located on a side of the fourth magnet away from the third magnet; the fifth magnet and the sixth magnet are provided opposite the third driving unit along the second direction.

8. The stepper motor of claim 7, wherein the housing comprises a first cover plate and a second cover plate provided opposite each other along the axial direction of the rotor assembly, wherein a side of the first iron core away from the second driving unit and a side of the second iron core away from the second driving unit are fixed to the first cover plate; a side of the fifth iron core away from the second driving unit and a side of the sixth iron core away from the second driving unit are fixed to the second cover plate; two ends of the first rotor shaft and two ends of the second rotor shaft are rotatably connected to the first cover plate and the second cover plate, respectively.

9. The stepper motor of claim 1, further comprising spacers sleeved on each of the rotor shafts, wherein the spacers are provided between the magnet group and the housing and/or between the adjacent magnets of the magnet group.

10. The stepper motor of claim 1, further comprising magnetic spacers sleeved on the rotor assembly, wherein the magnetic spacers are fixedly sandwiched between the two adjacent driving units.

11. The stepper motor of claim 1, further comprising bearings fixing the rotor shaft of each of the sub-rotor assemblies to the housing.

12. The stepper motor of claim 1, wherein the iron cores are formed by stacking multiple layers of iron sheets.
